(19) United States
(12) Patent Application Publication
(10) Pub. No.: US 2005/0194883 A1
(43) Pub. Date: Sep. 8, 2005

(54) Cathode ray tube

(75) Inventor: Tetsuya Masumura, Suita-shi (JP)

Correspondence Address: MERCHANT & GOULD PC, P.O. BOX 2903, MINNEAPOLIS, MN, 55402-0903, US

(73) Assignee: Matsushita Toshiba Picture Display Co., Ltd., Takatsuki-shi (JP)

(21) Appl. No.: 11/069,171

(22) Filed: Mar. 1, 2005

(30) Foreign Application Priority Data
Mar. 5, 2004 (JP) 2004-062904

(51) Int. Cl. H01J 29/86

(52) U.S. Cl. 313/477 R

(57) ABSTRACT

The object of the present invention is to provide a cathode ray tube that can prevent halation, reduce deflection power efficiently, and secure pressure resistance strength of a vacuum envelope. A vacuum envelope comprises a neck portion provided with an electron gun, and a cone portion that corresponds to a position where a deflection yoke is disposed and has a cross section taken along a direction perpendicular to a tube axis of the cathode ray tube, which is non-circular shaped, a panel portion is formed substantially symmetrically with respect to a long axis and a short axis that cross each other at a right angle, and wherein, in a cross section of the cone portion taken along the direction perpendicular to the tube axis, assuming that a substantial thickness of the cone portion on the long axis is represented by Th, a substantial thickness of the cone portion on the short axis is represented by Tv, and a minimum thickness of the cone portion in a diagonal position is represented by Td, there is the cross section satisfying a relationship of Th>Tv>Td.

### FIELD OF THE INVENTION

The present invention relates to a cathode ray tube provided with a deflection yoke, and particularly relates to a cathode ray tube that can decrease deflection power efficiently while suppressing electron beam from striking a cone portion of a funnel, and can secure pressure resistance strength of a vacuum envelope.

### BACKGROUND OF THE INVENTION

An example of a conventional cathode ray tube is described with reference to FIGS. 16 and 17. FIG. 16 is a perspective view showing an example of a vacuum envelope used in a conventional cathode ray tube. FIG. 17 is a perspective view showing an example of an internal structure of a conventional cathode ray tube. A vacuum envelope 1 includes a glass panel 2 having a substantially rectangular display part, a funnel-shaped glass funnel 3 with a large diameter portion connected to this panel 2, and a cylindrical glass neck 5 connected to a cone portion 4 of this funnel 3.

A phosphor screen 6 made of phosphor layers is provided inside the panel 2. The phosphor layers are dot-shaped or stripe-shaped three-colored phosphor layers that emit light in blue, green and red. A shadow mask 7 is disposed facing the phosphor screen 6. Many electron beam passing apertures are formed in the shadow mask 7. An electron gun 8 for emitting three electron beams is provided in the neck 5.

A deflection yoke 9 is provided from an outside of the cone portion 4 of the funnel 3 to an outside of the neck 5. The three electron beams are deflected by a horizontally deflecting magnetic field and a vertically deflecting magnetic field that are generated by the deflection yoke 9, and scan horizontally and vertically on the phosphor screen 6 via the shadow mask 7, thereby displaying a color image.

Among various kinds of cathode ray tubes, self-convergence-in-line-type cathode ray tubes are widely used. The cathode ray tube has the electron gun 8of the in-line-type that emits three electron beams that pass on the same horizontal plane and are arranged in a line. And the horizontally deflecting magnetic field generated by the deflection yoke 9 is set to have a pincushion-shape, and the vertically deflecting magnetic field is set to have a barrel-shape, these three electron beams arranged in a line are deflected by these horizontally deflecting magnetic field and vertically deflecting magnetic field, thereby converging onto the whole screen without a particular correction.

Since the deflection yoke 9 is a major source of power consumption in such a cathode ray tube, it is important to reduce the power consumption of this deflection yoke 9 for reducing the total power consumption of the cathode ray tube. That is, for enhancing the brightness of a screen, it is necessary to increase an anode voltage that finally accelerates electric beams. Moreover, in order to apply to a ID (high definition) TV or an OA equipment such as a personal computer, it is necessary to increase the deflection frequency. However, increasing either the anode voltage or the deflection frequency leads to increasing the deflection power.

Generally, in order to decrease the deflection power, it is necessary to decrease a diameter of the neck 5 of the cathode ray tube, and decrease an outer diameter of the cone portion 4 to which the deflection yoke 9 is provided, so that the deflecting magnetic field may act to the electron beams efficiently. In this case, the electron beams pass closely to an inner face of the cone portion 4 provided with the deflection yoke 9. Therefore, when further decreasing the diameter of the neck 5 and the outer diameter of the cone portion 4, the electron beams moving toward a diagonal corner of the phosphor screen 6, which have a maximum deflection angle, strike the inner face of the cone portion 4 of the funnel 3, and some of the electron beams do not reach the phosphor screen 6 due to a shadow of the inner face of the funnel 3. This phenomenon hereinafter is called a “beam neck shadow”.

In JP48(1973)-34349B (U.S. Pat. No. 3,731,129), by considering that, when displaying a rectangular raster on the phosphor screen 6, a passing region of the electron beams inside the cone portion 4 also has a substantially rectangular shape, the cone portion 4 provided with the deflection yoke 9, which has a configuration that a cross section thereof is circular-shaped on the neck 5 side, and gradually changes in shape to be substantially rectangular-shaped as being closer to the panel 2, is suggested as a means for solving the above-mentioned problem.

If the cone portion 4 provided with the deflection yoke 9 is formed in a pyramidal shape, the inner diameter of a diagonal corner (in the vicinity of a diagonal axis, that is, in the vicinity of an axis D) where the electron beams likely strike can be increased, so that the strike of the electron beams can be prevented more, compared with the cone portion 4 in the usual circular shape. In addition, by decreasing the inner diameter of the cone portion 4 in directions of a horizontal axis (an axis H) and a vertical axis (an axis V), and letting a horizontally deflecting coil and a vertically deflecting coil of the deflection yoke 9 be closer to the electron beams, the electron beams can be deflected more efficiently, thereby reducing the deflection power.

FIG. 18 shows how stresses are applied in the case where the shape of the cone portion 4 becomes closer to a substantially rectangular shape. As shown in FIG. 18, as the cone portion 4 is closer to the rectangular shape, distortion occurs to the cone portion 4 that is flattened by an atmospheric pressure load F as shown by a broken line 117. Here, compressive stresses σH and σV respectively are applied to an outer face in the vicinity of the horizontal axis 115 and an outer face in the vicinity of the vertical axis 116, and tensile stress σD is applied to an outer face in the vicinity of the diagonal axis 118. When such stresses are applied, pressure resistance strength of the vacuum envelope decreases, and reliability (safety) against the atmospheric pressure may be degraded.

Recently, since there has been a strong demand for preventing the reflection of external light and high visibleness, flattening of a panel is required. When a panel is flattened, its resistance strength against an atmospheric pressure load decreases. Thus, when a funnel provided with a pyramidal cone portion is used for a cathode ray tube with a flattened panel so as to reduce the deflection power, sufficient pressure resistance strength is not secured.

One of the means to solve the above-mentioned problem is suggested by JP10(1998)-154472A. FIG. 19 shows a cross section of the cone portion of JP10(1998)-154472A taken along a direction perpendicular to the tube axis. The cross section shown in FIG. 19 is in a non-circular shape having an outer diameter with a maximum thickness on the horizontal axis and the vertical axis. In this cross section, assuming a point where a line that crosses the tube axis at an angle θ with respect to the horizontal axis crosses the inner face of the cone portion is represented by Pi(θ), a distance from the point Pi(θ) to the horizontal axis is represented by Piv(θ), and a distance from the point Pi(θ) to the vertical axis is represented by Pih(θ), Piv(θ) or Pih(θ) has a portion protruding in the tube axis direction, which is shaped with a non-monotonically increasing or a decreasing function having at least one maximum value between the horizontal axis and the vertical axis. Thereby, an inner face of the cone portion is formed so that its cross section perpendicular to the tube axis may be in a pincushion shape, which is similar to a pincushion-shaped electron beam passing region in the cone portion.

Also, JP10(1998)-149785A suggests a structure that can secure the pressure resistance strength and reduce the deflection power efficiently, even when the cone portion is formed in a pyramidal shape. Assuming that a screen aspect ratio is represented by M:N, an outer diameter in the vertical axis direction is represented by SA, an outer diameter in the horizontal axis direction is represented by LA, and a maximum outer diameter of the cone portion (in an diagonal direction) is represented by DA, this structure satisfies a relationship of
(M+N)/(2×(M²+M²)^{1/2})<(SA+LA)/(2×DA)≦0.86.

Moreover, JP2000-149828A suggests a structure obtained by considering that, when electron beams are substantially deflected by a deflection yoke, there is a relatively larger deflection margin in a direction of a short axis V of a panel than in a direction of a long axis H and a direction for a diagonal corner D of the panel. Specifically, in the cross section of the cone portion perpendicular to the tube axis, a thickness of the cone portion satisfies the below-described formula, where a thickness of the cone portion in the direction of the long axis of the panel is represented by Tv, a thickness of the cone portion in the direction of the short axis of the panel is represented by Th, and a thickness of the cone portion in the diagonal direction of the panel is represented by Td.
Tv(z)>Th(z)>Td(z)

However, there is a problem regarding the above-mentioned cathode ray tube, which has been regarded with little importance. This will be described with reference to FIGS. 20A, 20B and 21. FIG. 20A is a cross section of one example of a conventional cathode ray tube, and FIG. 20B is a plan view of a panel screen of the cathode ray tube shown in FIG. 20A. FIG. 21 is a cross section of the cone portion 4 perpendicular to the tube axis on the screen 6 side. Reference numeral 20 denotes a connected portion of the cone portion 4 on the side of the screen, reference numeral 21 denotes a position of a reference line of the cone portion 4, and reference numeral 22 denotes a connected portion of the cone portion 4 on the side of the neck.

When displaying an image enlarged by up to 108% with respect to an image range (a maximum diameter of the screen between 6a and 6b in the diagonal direction) of the phosphor screen 6 shown in FIG. 20B, which is a standard range where electron beams generally are scanned by a NTSC system, the electron beams strike the inner face of the cone portion 4 in the vicinity of the diagonal axis 33 (see FIGS. 20A and 21).

The thus struck electron beams reflect, and cause scattering beams 31 (see FIG. 20A) to occur on a track that is different from a predetermined deflection track of the electron beams. In this case, the scattering beams 31 strike the whole phosphor screen 6, reaching the phosphor screen 6 without distinction of the color of the phosphor screen 6, which is red, green, or blue. Accordingly, the whole screen is caused to emit white light with low brightness, thereby degrading black-and-white contrast and color purity.

For example, when displaying in green on the whole display, the scattering beams 31 do not pass on the predetermined track, and reach the phosphor screen 6 without distinction of the color: red; green; or blue, which then causes the whole screen to emit white light with low brightness. Therefore, the screen displays in green that has less color purity, compared with the color of green that is predetermined to be displayed.

This phenomenon is called halation, which appears most distinctly when images are displayed in the dark room. For providing high-quality images of the recent digital high definition format, this halation is an important problem to be solved.

In the above-mentioned cathode ray tube, in order to prevent the halation, it is necessary to increase a distance from the tube axis to an inner wall of the cone portion in the vicinity of a diagonal axis so as to secure a sufficient margin for the electric beams, which is larger than a margin for preventing a beam neck shadow. Thus, in the cross section of the cone portion perpendicular to the tube axis, a cross-sectional thickness of the cone portion in the vicinity of the diagonal axis decreases, and thus pressure resistance strength of the vacuum envelope deteriorates. Whereas, when a distance from the tube axis to an outer wall of the cone portion in the vicinity of the diagonal axis is increased, an effect of the deflecting magnetic field with respect to the electron beams deteriorates, which leads to an increase the deflection power.

### SUMMARY OF THE INVENTION

In light of the above-stated conventional problems, it is an object of the present invention to provide a high-quality cathode ray tube that can prevent halation, reduce deflection power efficiently, and secure sufficient pressure resistance strength for a vacuum envelope.

In order to attain the above-mentioned object, the cathode ray tube of the present invention comprises: a vacuum envelope that is provided with an electric gun and includes a panel portion with a phosphor screen formed on an inner face thereof, and a deflection yoke that is disposed on a periphery of the vacuum envelope and deflects electron beams emitted from the electron gun, wherein the vacuum envelope comprises a neck portion provided with the electron gun, and a cone portion that corresponds to a position where the deflection yoke is disposed and has a cross section taken along a direction perpendicular to a tube axis of the cathode ray tube, which is non-circular shaped in substantially all regions in the direction of the tube axis, the panel portion is formed substantially symmetrically with respect to a long axis and a short axis that cross each other at a right angle, and wherein, in a cross section of the cone portion taken along the direction perpendicular to the tube axis, assuming that a substantial thickness of the cone portion on the long axis is represented by Th, a substantial thickness of the cone portion on the short axis is represented by Tv, and a minimum thickness of the cone portion in a diagonal position is represented by Td, there is the cross section satisfying a relationship of Th>Tv>Td.

These and other advantages of the present invention will become apparent to those skilled in the art upon reading and understanding the following detailed description with reference to the accompanying figures.

### BRIEF DESCRIPTION OF THE DRAWINGS

FIG. 1 is a cross section of a cathode ray tube of the present invention.

FIG. 2 is a plan view of a panel of the cathode ray tube shown in FIG. 1.

FIG. 3A is a cross section of a cone portion according to one embodiment of the present invention at an end on a neck side, taken along a direction perpendicular to a tube axis.

FIG. 3B is a cross section of the cone portion according to one embodiment of the present invention in the vicinity of a reference line, taken along the direction perpendicular to the tube axis.

FIG. 3C is a cross section of the cone portion according to one embodiment of the present invention at an end on a screen side, taken along the direction perpendicular to the tube axis.

FIG. 4 is a view showing a logic for obtaining a shape of an inner face of the cone portion according to one embodiment of the present invention.

FIG. 5 is a view for describing an example of an electron beam track of the cone portion.

FIG. 6 is a cross section of the cathode ray tube taken along the direction perpendicular to the tube axis, which shows a logic for obtaining the cone portion according to one embodiment of the present invention.

FIG. 7 is a cross section of the cone portion of the cathode ray tube according to one embodiment of the present invention, taken along the direction perpendicular to the tube axis.

FIG. 8 is a view showing a relationship between Th/Tv and a maximum vacuum stress of the cathode ray tube according to one embodiment of the present invention.

FIG. 9 is a view showing a relationship between Th/Tv and a maximum vacuum stress of a cathode ray tube according to a comparative example.

FIG. 10 is a view showing a relationship between a position of the cone portion and a cross-sectional thickness in each part of the cathode ray tube according to one embodiment of the present invention.

FIG. 11 is a view showing a relationship between a position of the cone portion and a cross-sectional thickness in each part of the cathode ray tube according to the comparative example.

FIG. 12 is a view showing a relationship between a position of the cone portion and Th/Tv according to one embodiment of the present invention.

FIG. 13 is a view showing a relationship between the position of the cone portion and Th/Tv according to the comparative example.

FIG. 14 a cross section of the cone portion of the cathode ray tube according to one embodiment of the present invention, taken along the direction perpendicular to the tube axis.

FIG. 15 is a view showing a relationship between the position of the cone portion and ΔH-ΔV>1 of the cathode ray tube according to one embodiment of the present invention.

FIG. 16 is a perspective view of one example of a conventional cathode ray tube.

FIG. 17 is a perspective view showing an inner structure of one example of the conventional cathode ray tube.

FIG. 18 is a view showing how stresses are applied to a cone portion of the conventional cathode ray tube.

FIG. 19 is a cross section of the cone portion according to one example of the conventional cathode ray tube, taken along a direction perpendicular to a tube axis.

FIG. 20A is a perspective structural view of one example of the conventional cathode ray tube.

FIG. 20B is a plan view of a panel of the cathode ray tube shown in FIG. 18A.

FIG. 21 is a view for describing halation according to one example of the conventional cathode ray tube.

### DESCRIPTION OF THE PREFERRED EMBODIMENTS

The present invention can provide a high-quality cathode ray tube that can prevent halation, reduce deflection power efficiently, and secure sufficient pressure resistance strength of a vacuum envelope.

The present invention can provide a high-quality cathode ray tube that can prevent halation, reduce deflection power efficiently, and secure pressure resistance strength of a vacuum envelope sufficiently, because a thickness Th of the cone portion on a long axis, a thickness Tv of the cone portion on a short axis and a minimum thickness Td of the cone portion in a position of a diagonal corner satisfy a relationship of Th>Tv>Td.

In the cathode ray tube of the present invention, it is preferable that the relationship is satisfied in a range from a position of a reference line that is a reference for a deflection angle to a position that is 85% of a distance from the position of the reference line to an end of the cone portion on the panel portion side. Moreover, it is preferable that a relationship of Th/Tv≧1.1 is satisfied in the range. These preferable structures are advantageous in securing the pressure resistance strength.

Furthermore, it is preferable that, in a cross section satisfying the relation, assuming that a substantial thickness in a region sandwiching the long axis in a direction of the long axis is represented by Th′, a substantial thickness in a region sandwiching the short axis in a direction of the short axis is represented by Tv′, and lengths of the regions are equal, there is a range in the regions satisfying a relationship of Th′>Tv′. According to this structure, formation is easy and distributions of the stresses may be smooth.

In addition, it is preferable that a relationship of Th/Tv≧1.2 is satisfied, and the range of the regions is a range where a distance from each of the axes is smaller than 17 mm.

Moreover, it is preferable that a relationship of Th/Tv>1.1 is satisfied, and the range of the regions is a range where a distance from each of the axes is 10 mm or smaller.

In addition, it is preferable that the cross sections of the cone portion in respective positions on the tube axis in a range from a position of a reference line that is a reference for a deflection angle to an end of the cone portion on the panel portion side satisfies a relationship of Th/Tv>1, and there is a maximal value of Th/Tv in the range. This structure can prevent the halation and improve efficiencies in securing the pressure resistance strength of the vacuum envelope.

Moreover, it is preferable that the maximal value ranges between 1.11 and 1.39 inclusive. This structure can prevent a decrease of the pressure resistance strength due to excess reduction of Tv comparing with Th.

Furthermore, it is preferable that, in the cross section of the cone portion taken along the direction perpendicular to the tube axis, assuming that a point which has a longest distance from the tube axis in a horizontal direction among points on a vertical inner face of the cone portion is represented by rdh, a point which has a longest distance from the tube axis in the vertical direction among points on a horizontal inner face of the cone portion is represented by rdv, a maximum height of the vertical inner face in the horizontal direction from a vertical line passing on the point rdh is represented by ΔH, and a maximum height of the horizontal inner face in the vertical direction from a horizontal line passing on the point rdv is represented by ΔV, the cross sections in the respective positions on the tube axis in a range from the position of the reference line to the end of the cone portion on the panel portion side satisfy a relationship of ΔH>ΔV. This structure can prevent the electron beams from striking the inner wall of the cone portion at the diagonal corner, and striking the inner wall in the vicinity of the short axis.

Moreover, it is preferable that, in a range between a position that is substantially middle of the range from the position of the reference line to the end of the cone portion on the panel portion side and the end of the cone portion on the panel portion side, a value of ΔH-ΔV increases closer to the panel portion side. This structure increases the value of ΔH-ΔV in the range where the track of the electron beam leans to the horizontal axis side, so as to enhance the reliability of preventing the electron beams from striking the inner wall at the diagonal corner.

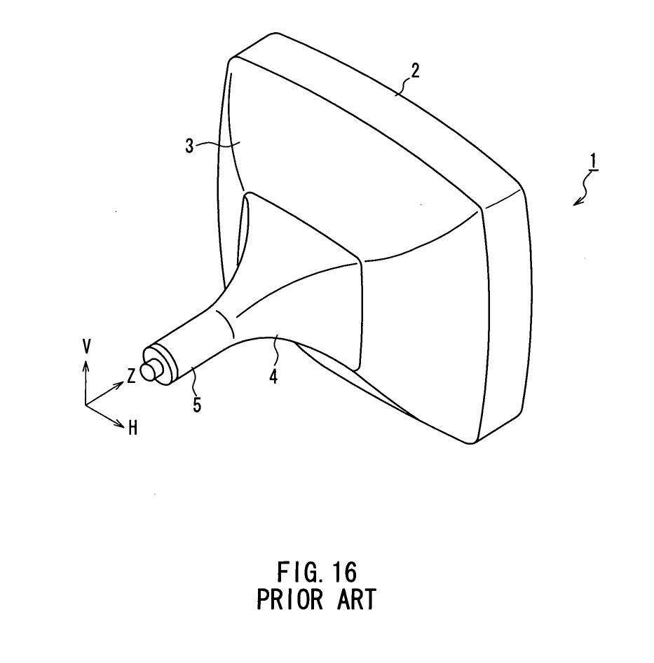

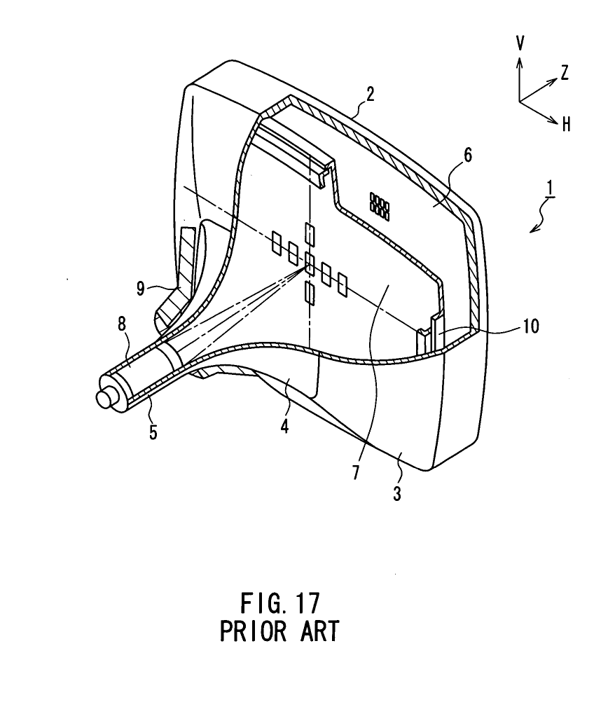

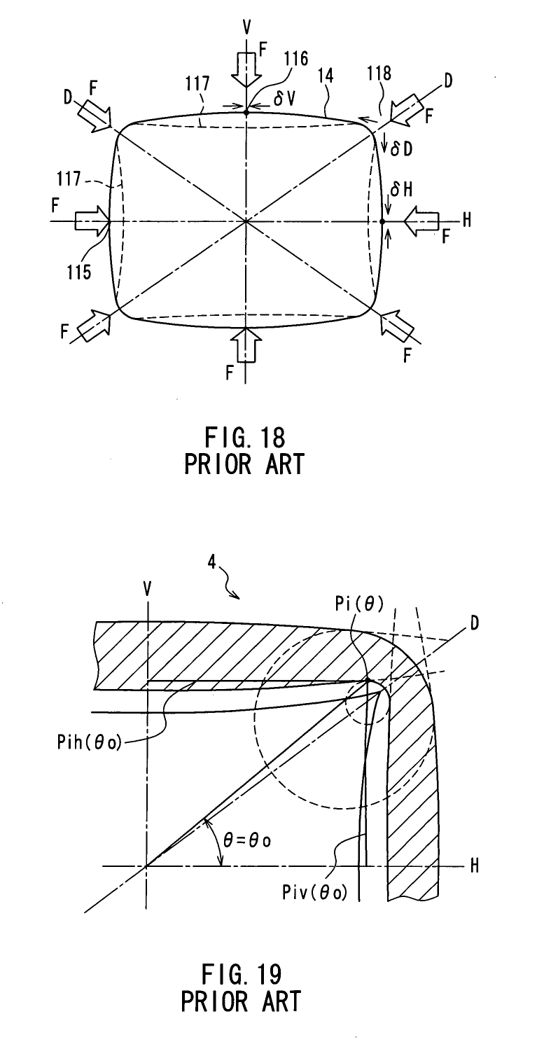

One embodiment of the present invention will be described below with reference to the drawings. A basic structure shown in FIGS. 16 and 17 also is applied to the present embodiment. That is, a cathode ray tube is composed of a vacuum envelope 1 that includes: a rectangular panel 2 where a long axis is a horizontal axis (an axis H) and a short axis is a vertical axis (an axis V); a funnel-shaped funnel 3 connected to the panel 2; and a cylindrical neck portion 5 connected to the funnel 3. On a periphery of the funnel 3, a deflection yoke 9 is provided to a cone portion 4 which spreads wider from a the connection on the side of the neck portion 5 to the connection on the panel 2 side. In addition, a phosphor screen 6 is formed on an inner face of the panel 2, and an electron gun 8 is inserted into an inside of the neck portion 5.

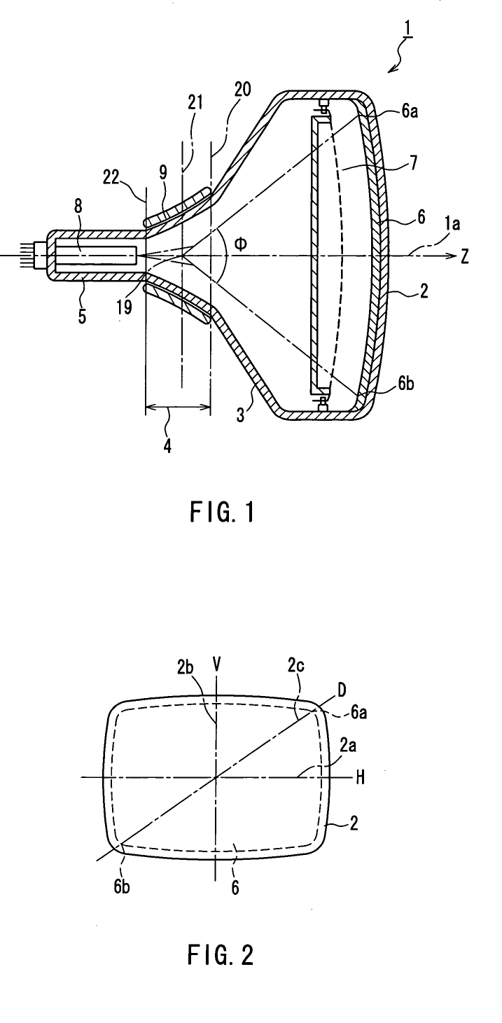

FIG. 1 shows a cross section of the cathode ray tube according to one embodiment of the present invention. FIG. 2 is a plan view of the panel 2 of the cathode ray tube shown by FIG. 1. The deflection yoke 9 is provided on the periphery of the funnel 3, and a portion in the funnel 3, at which the deflection yoke is provided, is a cone portion 4. Lines 20 and 22 respectively denote positions of ends of the cone portion 4 in the direction of the tube axis 1a, which are parts where other parts are connected to the cone portion 4. Hereinafter, the line 20 showing the end of the cone portion 4 on the panel 2 side is called a connected portion 20, and the line 22 showing the end of the cone portion 4 on the electron gun 8 side is called a connected portion 22.

The panel 2 is symmetrical with respect to a horizontal axis 2a (an axis H) and a vertical axis 2b (an axis V). Three electron beams emitted from the electron gun 8 are deflected by the defection yoke 9 in directions of the horizontal axis 2a and the vertical axis 2b of the panel 2. The electron beams pass through electron beam passing apertures in a shadow mask 7 that is provided inside the panel 2, and land on the phosphor screen 6, thereby displaying a predetermined image.

The cathode ray tube has a deflection angle φ according to a model thereof. The deflection angle φ is determined at a position of the reference line 21 (a deflection standard position).

When an angle formed by two lines that respectively connect diagonal corners 6a and 6b (see FIG. 2) on the phosphor screen 6 with an arbitrary point 19 on the tube axis 1a (an axis Z) is equal to the deflection angle φ of the cathode ray tube, a line crossing the tube axis 1a at the point 19 (a deflection center) on the tube axis at a right angle is represented by the reference line.

Usually, when designing the funnel 3, the deflection angle φ is considered, and the reference line 21 is determined according to a screen size. In this case, even if the deflection angle φ is the same, the position of the reference line 21 differs when the screen size differs. However, when the deflection angle φ is obtained, since the screen size is fixed with respect to one cathode ray tube, one reference line 21 must be determined uniquely.

In addition, the reference line is defined by the deflection angle of the cathode ray tube as mentioned above, and the position of the reference line can be obtained by providing a standardized reference line gage to the neck portion 5.

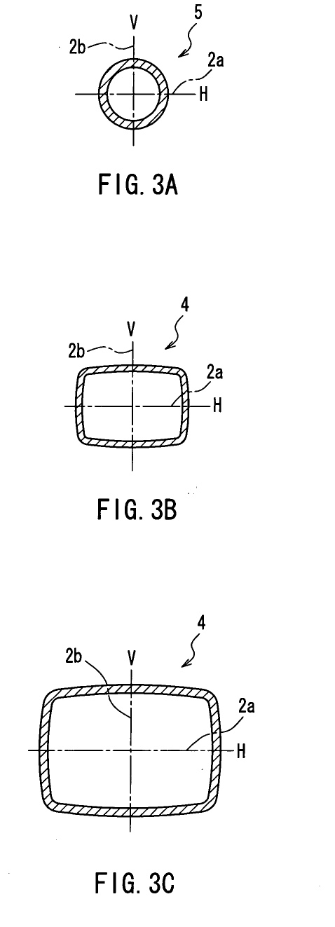

Next, FIGS. 3A, 3B and 3C respectively show cross sections of the vacuum envelope 1 shown in FIG. 1, taken along a direction perpendicular to the tube axis. FIG. 3A is a cross section in the vicinity of the connected portion 22, FIG. 3B is a cross section in the position of the reference line 21, and FIG. 3C is a cross section in the vicinity of the connected portion 20. As shown in these figures, the cone portion 4 provided with the deflection yoke 9 is formed in a substantially pyramidal shape. That is, as shown in FIG. 3A, the cross section of the vacuum envelope 1 taken along the direction perpendicular to the tube axis 1a is circular-shaped in the vicinity of the connected portion 22, which has the substantially same shape as the neck portion 5,. However, the cross section of the vacuum envelope 1 is in a substantially rectangular shape (a non-circular shape) from the vicinity of the reference line 21 as shown in FIG. 3B to the connected portion 20 as shown in FIG. 3C. Note here that FIGS. 3A, 3B and 3C are schematic views just for describing that the cross section of the vacuum envelope 1 perpendicular to the tube axis is substantially rectangular-shaped at the cone portion, whereas it is circular-shaped at the connected portion 22 on the side of the neck. A more detailed description of the shape will be provided below.

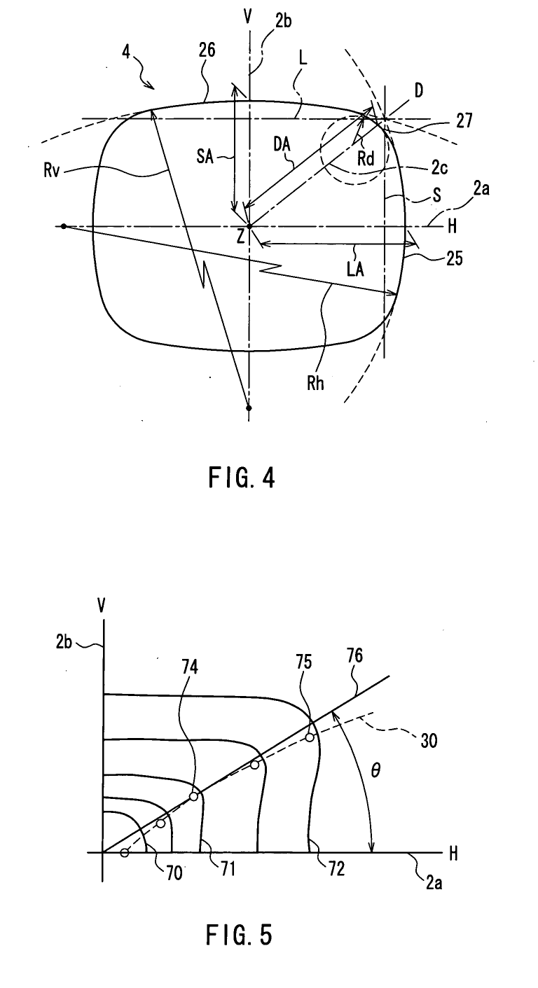

A logic for leading to the present invention will be described with reference to FIGS. 4, 5 and 6. FIG. 4 is a view of a cone portion assumed to have a most simple shape of an inner face or an outer face, for studying a specific shape of the cone portion. The cone portion 4, except in the vicinity of the connected portion on the side of the neck, includes the horizontal axis 2a of the phosphor screen, an arc 25 with a radius of Rh having a center on the horizontal axis 2a, the vertical axis 2b of the phosphor screen, an arc 26 with a radius of Rv having a center on the vertical axis 2b, and an arc 27 with a radius of Rd having a center on the diagonal axis 2c (the axis D) and connected smoothly to the arcs 25 and 26.

Assuming that a distance from the tube axis to the arc 25 in a direction of the horizontal axis 2a is represented by LA, a distance from the tube axis to the arc 26 in a direction of the vertical axis 2b is represented by SA, and a distance from the tube axis to the arc 27 in a direction of the diagonal axis 2c, which is a maximum diameter is represented by DA, the cone portion 4 is formed in a substantially rectangular shape where LA and SA are smaller than DA.

FIG. 5 is a view showing a track of the electron beams passing in a region of the cone portion 4. In FIG. 5, lines connecting the horizontal axis 2a with the vertical axis 2b represent cross sections of the inner face of the cone portion 4 of the vacuum envelope 1, taken along the direction perpendicular to the tube axis. For example, a line 70 represents the inner face at the connected portion 22 (see FIG. 1), a line 71 denotes the inner face in the position of the reference line 21 (see FIG. 1), and a line 72 denotes the inner face at the connected portion 20 (see FIG. 1).

A dotted line 30 represents a track of the electron beam that passes in the region of the cone portion 4 to reach the diagonal corner 6a of the phosphor screen 2 as shown in FIG. 1,. This is, more specifically, it is a projection of the track of the electron beam on a plane that is parallel to the phosphor screen 2. For example, a point 74 represents a position of the electron beam in the vicinity of the reference line 21, and a point 75 represents a position of the electron beam in the vicinity of the connected portion 20. As shown in FIG. 5, it is found that the electron beam passes in the vicinity of the inner face.

Usually, the three in-line arranged electron beams emitted from the electron gun 8 are deflected in an aspect ratio of the phosphor screen 2 of M:N (for example, 16:9 or 4:3). At the same time, in the case where the deflection yoke 9 is convergence-free, the electron beam provides a deflection track as shown by the dotted line 30 so that an angle θ from the horizontal axis 2a may be maximum when the position of the electron beam is at a deflection center, that is, in the vicinity of the position of the reference line. More specifically, among lines connecting the tube axis and the positions of the electron beam, the line 76 that connects the tube axis and the point 74 in the vicinity of the line 71 provides a largest gradient.

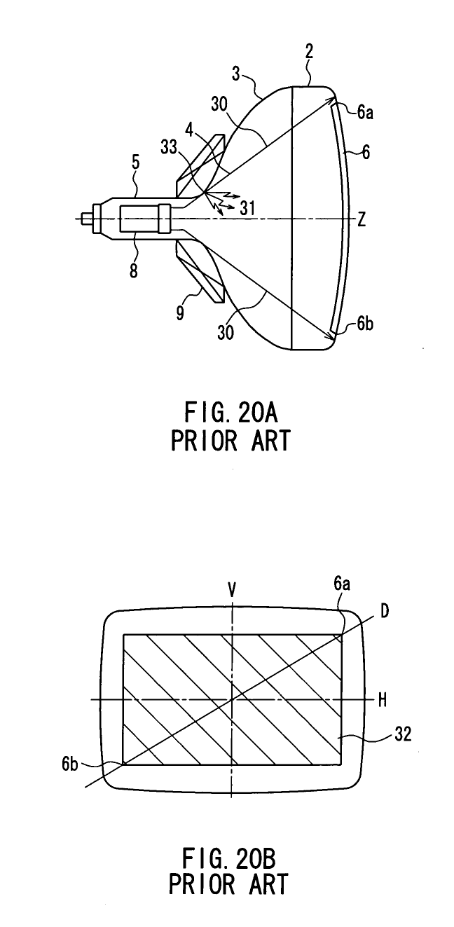

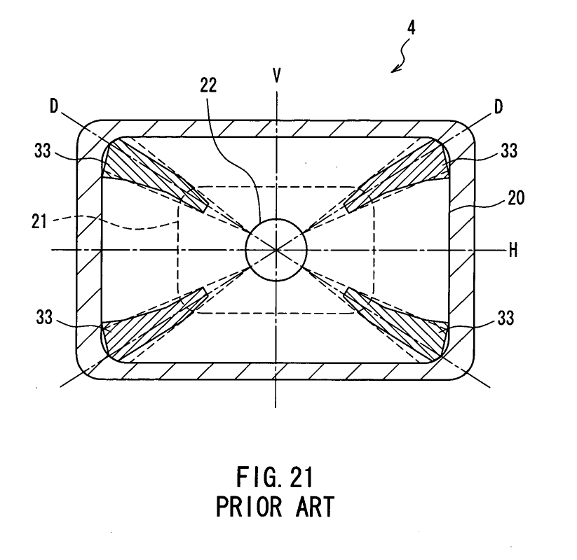

It is necessary to determine the inner face of the cone portion 4 by considering the substantial track of the electron beams emitted from the electron gun 8 so that the inner face in the vicinity of the diagonal corners of the cone portion 4 may secure a larger margin with respect to the track of the electron beams than a margin required for preventing a beam neck shadow, thereby preventing halation, which requires a more strict limitation than preventing the beam neck shadow. That is, the inner face determined for preventing the halation also can prevent the beam neck shadow. Here, the beam neck shadow and the halation are described above with reference to FIGS. 20A, 20B and 21.

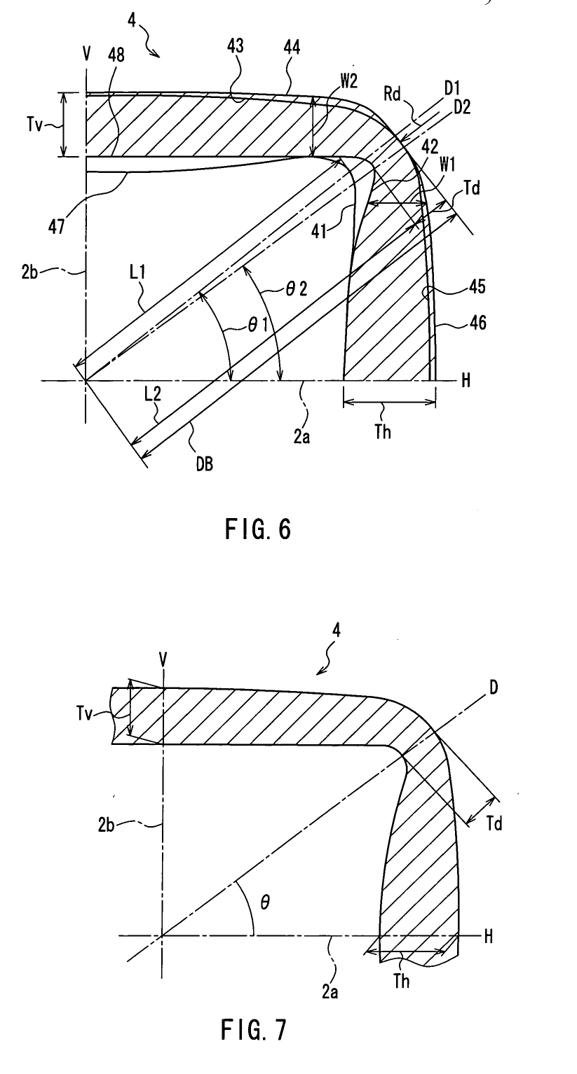

FIG. 6 shows the cone portion 4 in the vicinity of the connected portion 20, where inner faces 42 and 48 are set so as to prevent the halation by considering the substantial track of the electron beams. Inner faces 41 and 47 are shaped for preventing the beam neck shadow. A diagonal axis D1 represents a line connecting a point on the tube axis with a point on an inner face 41 that has a maximum distance from the point on the tube axis. An angle formed by the diagonal axis D1 and the horizontal axis 2a is represented by θ1.

A diagonal axis D2 represents a line connecting a point on the tube axis and a point on the inner face 42 having a maximum distance therefrom. An angle formed by the diagonal axis D2 and the horizontal axis 2a is represented by θ2. The distance L2 between the tube axis and the inner face 42 on the diagonal line D2 is longer than the distance L1 between the tube axis and the inner face 41 on the diagonal line D1. In addition, the angle θ2 is smaller than the angle θ1.

In addition, Th denotes a thickness of a tube wall of the cone portion on the horizontal axis 2a, and Tv denotes a thickness of the tube wall of cone portion on the vertical axis 2b. In FIG. 6, Tv is the thickness as described below in detail, in the case of assuming the inner wall as the inner face 48.

Moreover, in the cathode ray tube, the vacuum resistance strength and the deflection power are important for setting the outer face of the cone portion 4. That is, the cone portion is required to satisfy standards on the vacuum resistance strength and the deflection power, as well as the standard for preventing the halation.

Since the inner face 42 of the cone portion 4 shown in FIG. 6 has a configuration where the distance on the diagonal axis is increased from L1 to L2 while maintaining an outer diameter DB, the minimum thickness Td in the vicinity of the diagonal corner is decreased, which leads to the disadvantage in securing the vacuum resistance strength. If the outer face of the cone portion 4 becomes wider outward, the thickness Td may be increased. However, since a diameter of the deflection yoke 4 is increased accordingly, the efficiency of the deflecting magnetic field that acts on the electron beams deteriorates, thus leading to an increase in the deflection power.

In this case, when the outer face is formed so that the radius Rd of curvature having a center on the diagonal axis D2 may be larger, tensile stress σD (see FIG. 18) in the vicinity of the diagonal axis can be suppressed. According to this structure, the strength of the diagonal corner can be secured while maintaining the outer diameter DB.

In addition, by increasing the radius Rd of curvature, an outer surface 45 is set to be an outer surface 46, and thus the thickness of the vertical wall increases, thereby suppressing the compressive stress σH (see FIG. 18) in the direction of the horizontal axis 2b. Similarly, an outer surface 43 is set to be an outer surface 44, and thus the thickness of the horizontal wall also increases, thereby suppressing the compressive stress σV (see FIG. 18) in the direction of the horizontal axis. That is, a wall at the diagonal corners, a vertical wall and a horizontal wall, in isolation, respectively increase in strength.

However, as mentioned above, the angle θ2 that is formed by the horizontal axis 2a and the diagonal axis D2 is set to be smaller than the angle θ1 that is formed by the vertical axis 2a and the diagonal axis D1 so that a concavity of the wall at the diagonal corner may be deeper in the direction of the horizontal axis 2a. Thereby, in the vicinity of the diagonal corner, a width W2 of the horizontal wall is larger than a width W1 of the vertical wall.

Therefore, in the vicinity of the diagonal corner, W2 is relatively larger than Td and W1. That is, the stress σV is relatively smaller than the stresses σH and σD, causing a difference in stress. More specifically, a difference in strength between the vertical wall in the vicinity of the horizontal axis 2a and the vertical wall in the vicinity of the diagonal corner is larger than a difference in strength between the horizontal wall in the vicinity of the vertical axis 2b and the horizontal wall in the vicinity of the diagonal corner. That is, the stress concentrates to a point where the difference is large in strength at the diagonal corner, which may cause deterioration of the vacuum resistance strength.

Then, in order to prevent the deterioration of the vacuum resistance strength, the thickness Tv of the horizontal wall to which a relatively small stress is applied is decreased, and a stress applied to the whole horizontal wall is increased, whereby the stress concentration in the vicinity of the diagonal corner is released According to this structure, Tv is smaller than Th, whereas the conventional structure satisfies the relationship of Tv>Th>Td, which is dictated by considering the deflection margin for preventing the beam neck shadow. That is, this structure aims to prevent the halation that requires more strict structural limitation than preventing the beam neck shadow, and the deterioration of the deflection power and the vacuum resistance strength.

FIG. 7 is a view showing the feature of the present invention attained in the light of the above-mentioned points, which is a cross section of the cone portion 4 in the vicinity of the connected portion 20, taken along the direction perpendicular to the tube axis. Here, the cone portion 4 is formed so as to satisfy the relationship of Th>Tv>Td. The structure of FIG. 7 is modified by the structure of FIG. 6, by setting an inner face 47 to be an inner face 48 so as to reduce Tv, thereby increasing the stress applied to the whole horizontal wall. Various tests performed for examining the effect of this structure will be described specifically below.

Table 1 below shows the test results of evaluations on the halation, the deflection power and the pressure resistance strength (a maximum vacuum stress) in examples where the relationship of Th>Tv>Td is satisfied, and comparative examples where this relationship is not satisfied. The value of the each dimension shown in FIG. 1 is obtained by measuring in a position that is 20 mm away from the reference line 21 to the screen side.

In Table 1, “satisfied” denotes the standard was satisfied, and “not satisfied” denotes the standard was not satisfied. When the deflection power and the pressure resistance strength are 100% or less, the standards thereon are satisfied. The pressure resistance strength of 100% or less means that the maximum vacuum stress is lower than the standard value. The letters Th, Tv, Td, DA, θ and Rd in Table 1 are already described above with reference to FIGS. 6 and 7.

Generally, a maximum range for overscanning the display of an image is approximately 108% with respect to an image range of a screen of a TV set. That is, the halation does not occur, when electron beams in a overscan range of 108% do not strike the inner face of the cone portion, or when a range of the inner face of the cone portion where the electron beams strike is 10 mm or less in length in the direction of the tube axis. It is ascertained that the halation does not occur in the cathode ray tube when satisfying the above-mentioned conditions, and thus the standard for the evaluation on the halation is based on the satisfaction of these conditions.

TABLE 1

| | | | | | | | pressure | inner | | | |
|---|---|---|---|---|---|---|---|---|---|---|---|
| | | Th | Tv | Td | | deflection | resistance | face | θ | Rd | |
| | | (mm) | (mm) | (mm) | halation | power | strength | DA(mm) | (°) | (mm) | Th/Tv |
| A | Comparative | 7.0 | 7.3 | 5.3 | not | 90% | 85% | 49.8 | 34.5 | 16.1 | 0.96 |
| 76 cm | example 1 | | | | satisfied | satisfied | satisfied | | | | |
| | Comparative | 7.0 | 7.3 | 4.9 | satisfied | 90% | 111% | 50.2 | 34.0 | 16.1 | 0.96 |
| | example 2 | | | | | satisfied | not | | | | |
| | | | | | | | satisfied | | | | |
| | Example 1 | 7.8 | 6.5 | 4.9 | satisfied | 91% | 83% | 50.2 | 34.0 | 16.7 | 1.20 |
| | | | | | | satisfied | satisfied | | | | |
| B | Comparative | 7.3 | 7.6 | 6.2 | not | 89% | 85% | 51.2 | 34.5 | 16.1 | 0.96 |
| 86 cm | example 3 | | | | satisfied | satisfied | satisfied | | | | |
| | Comparative | 7.3 | 7.6 | 5.9 | satisfied | 89% | 112% | 51.5 | 34.0 | 16.1 | 0.96 |
| | example 4 | | | | | satisfied | not | | | | |
| | | | | | | | satisfied | | | | |
| | Example 2 | 8.1 | 6.7 | 5.9 | satisfied | 90% | 83% | 51.5 | 34.0 | 16.7 | 1.21 |
| | | | | | | satisfied | satisfied | | | | |
| C | Comparative | 6.5 | 7.0 | 5.2 | not | 92% | 89% | 52.5 | 34.5 | 16.0 | 0.93 |
| 66 cm | example 5 | | | | satisfied | satisfied | satisfied | | | | |
| | Comparative | 6.5 | 7.0 | 4.7 | satisfied | 92% | 115% | 53.0 | 32.0 | 16.0 | 0.93 |
| | example 6 | | | | | satisfied | not | | | | |
| | | | | | | | satisfied | | | | |
| | Example 3 | 7.1 | 6.3 | 4.7 | satisfied | 93% | 90% | 53.0 | 32.0 | 16.7 | 1.13 |
| | | | | | | satisfied | satisfied | | | | |

First, Group A (Comparative example 1, Comparative example 2 and Example 1) in which each sample had a screen size of 76 cm, will be described. In Group A, the standard for the beam neck shadow was satisfied, which is not shown in Table 1. Moreover, since each sample had a uniform length of a diagonal axis from a tube axis to an outer face, which corresponded to the outer diameter DB in FIG. 6, the condition on the deflection power was satisfied in all the samples in Group A. This was the same in Groups B and C.

In Comparative example 1, the halation occurred. In Comparative example 2, an inner face was set to have the distance DA of 50.2 mm, which was longer than DA of 49.8 mm in Comparative example 1. In addition, an angle θ was set to be 34° in Comparative example 2, which was smaller than θ of 34.5° in Comparative example 1. This was similar to the case where the inner face 41 was changed to the inner face 42 in FIG. 6.

As a result, it was possible to prevent the occurrence of the halation. However, the pressure resistance strength was not satisfied, whereas it was satisfied in Comparative example 1. This was thought to be because the thickness Td became 4.9 mm, which was smaller than Td of 5.3 mm in Comparative example 1, due to the increase of the distance DA.

In Example 1, while the distance DA was maintained, the radius Rd of the outer face was set to be 16.7 mm, which was larger than Rd of 16.1 mm in Comparative example 2. When increasing the radius Rd of the outer face, both of Th and Tv usually increase, but in Example 1, Th and Tv were set without increasing Tv so as to satisfy a relationship of Th (7.8 mm)>Tv (6.5 mm), which was inverse to the relationship of Th and Tv in Comparative example 1. As a result, it was possible to satisfy the pressure resistance strength.

Next, Group B (Comparative example 3, Comparative example 4 and Example 2) included samples with a screen size of 86 cm, which was larger than those in Group A. In Comparative example 3, halation occurred. The inner face of Comparative example 4 was set to have the distance DA of 51.5 mm, which was larger than DA of 51.2 mm in Comparative example 3. In addition, the angle θ was set to be 34° in Comparative example 4 , which was smaller than θ of 34.5° in Comparative example 3. As a result, it was possible to prevent the occurrence of the halation similarly to Comparative example 2, but the pressure resistance strength was not satisfied, which was satisfied in Comparative example 3. This was thought to be because the thickness Td became 5.9 mm, which was smaller than Td of 6.2 mm in Comparative example 3, due to the increase of the distance DA similarly to Comparative example 2.

In Example 2, while maintaining the distance DA, the radius Rd of the outer face was set to be 16.7 mm, which was longer than Rd of 16.1 mm in Comparative example 4. Similarly to Example 1, Th and Tv were set without increasing Tv so as to satisfy the relationship of Th (8.1 mm)>Tv (6.7 mm), which was inverse to the relationship of Th and Tv in Comparative example 4. As a result, it was possible to satisfy the pressure resistance strength.

Next, Group C (Comparative example 5, Comparative example 6 and Example 3) included samples with a screen size of 66 cm, which was smaller than those in Group A. In Comparative example 5, the halation occurred. The inner face of Comparative example 6 was set to have the distance DA of 53 mm, which was larger than DA of 52.5 mm in Comparative example 5. In addition, the angle θ was set to be 32° in Comparative example 6, which was smaller than θ of 34.50 in Comparative example 5. As a result, it was possible to prevent the occurrence of the halation similarly to Comparative examples 2 and 4, but the pressure resistance strength was not satisfied, which was satisfied in Comparative example 5. This was thought to be because the thickness Td became 4.7 mm, which was smaller than Td of 5.2 mm in Comparative example 5, due to the increase of the distance DA similarly to Comparative examples 2 and 4.

In Example 3, while maintaining the distance DA, the radius Rd of the outer face was set to be 16.7 mm, which was longer than Rd of 16 mm in Comparative example 6. Similarly to Examples 1 and 2, Th and Tv were set without increasing Tv so as to satisfy the relationship of Th (7.1 mm)>Tv (6.3 mm), which was inverse to the relationship of Th and Tv in Comparative example 6. As a result, it was possible to satisfy the pressure resistance strength.

From the results shown in Table 1, it is found that the structure satisfying the relationship of Th>Tv>Td is, regardless of the screen size is effective for preventing the halation and satisfying the pressure resistance strength, without increasing an outer diameter, that is, without increasing the required deflection power.

Moreover, another test was performed for examining the relationship of Th and Tv with the pressure resistance strength in further detail. The relationship between Th/Tv and the maximum vacuum stress will be shown below in Table 2. The values of Th and Tv shown in Table 2 were obtained by measuring in a position that is 20 mm away from the reference line 21 to the screen side.

TABLE 2

| | | | | pressure | | |
|---|---|---|---|---|---|---|
| | | | | resistance | | |
| | Th | Tv | Th/Tv | strength | Rd | DA |
| sample 1 | 7.6 | 6.8 | 1.12 | 88% | 16.7 | 50.2 |
| sample 2 | 7.7 | 6.6 | 1.17 | 85% | 16.7 | 50.2 |
| sample 3 | 7.9 | 6.1 | 1.30 | 100% | 16.7 | 50.2 |
| sample 4 | 7.9 | 5.9 | 1.35 | 106% | 16.7 | 50.2 |
| sample 5 | 7.2 | 7.4 | 0.97 | 112% | 16.7 | 50.2 |

All the samples shown in Table 2 had a screen size of 76 cm, 50.2 mm of the diagonal distance DA of the inner face, and 16.7 mm of the radius Rd of the outer face.

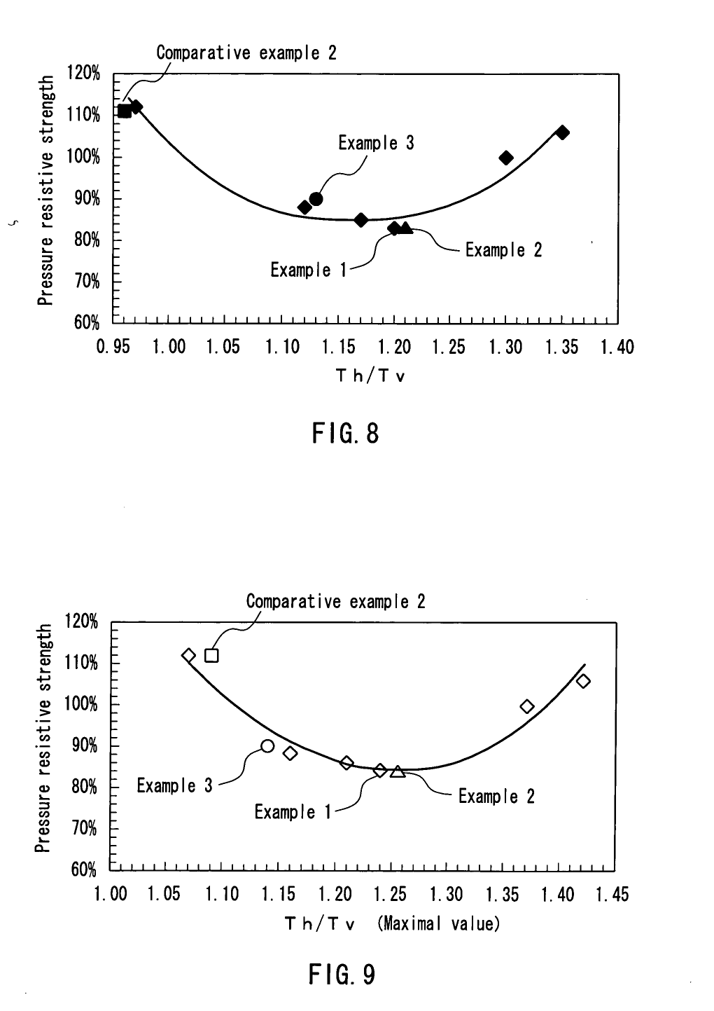

FIG. 8 illustrates the test results shown in Table 2. In FIG. 8, the values obtained in Examples 1 to 3 and Comparative example 2shown in Table 1 also are plotted. As shown in FIG. 8, as the value of Th/Tv increases from a value smaller than 1, the pressure resistance strength decreases, and has a substantially minimum value in Examples 1 and 2, where the value of Th/Tv is between 1.20 and 1.21. After that, the pressure resistance strength turns to increase, and the pressure resistance strength of Sample 4 is above 100%, where the value of Th/Tv is 1.35. This is thought to be because, when Tv is excessively small relatively to Tv, the strength of the horizontal wall decreases excessively, and thus the pressure resistance strength fails to satisfy the standard.

FIG. 9 is a graph with respect to the samples plotted in FIG. 8, which is modified by replacing the value of Th/Tv in FIG. 8 by a maximal value of Th/Tv in the whole range of the cone portion of the each sample. According to FIG. 9, it is found that, when the maximal value of Th/Tv ranges between 1.11 and 1.39 inclusive, the pressure resistance strength can be suppressed to be 100% or less.

From the test result in Table 2, when Tv is excessively small relative to Th, the pressure resistance strength decreases, which is necessary to be considered in designing. However, this does not result from the relationship of Th>Tv itself, and also occurs similarly when Th is excessively small relative to Tv in the case of satisfying the relationship of Th<Tv.

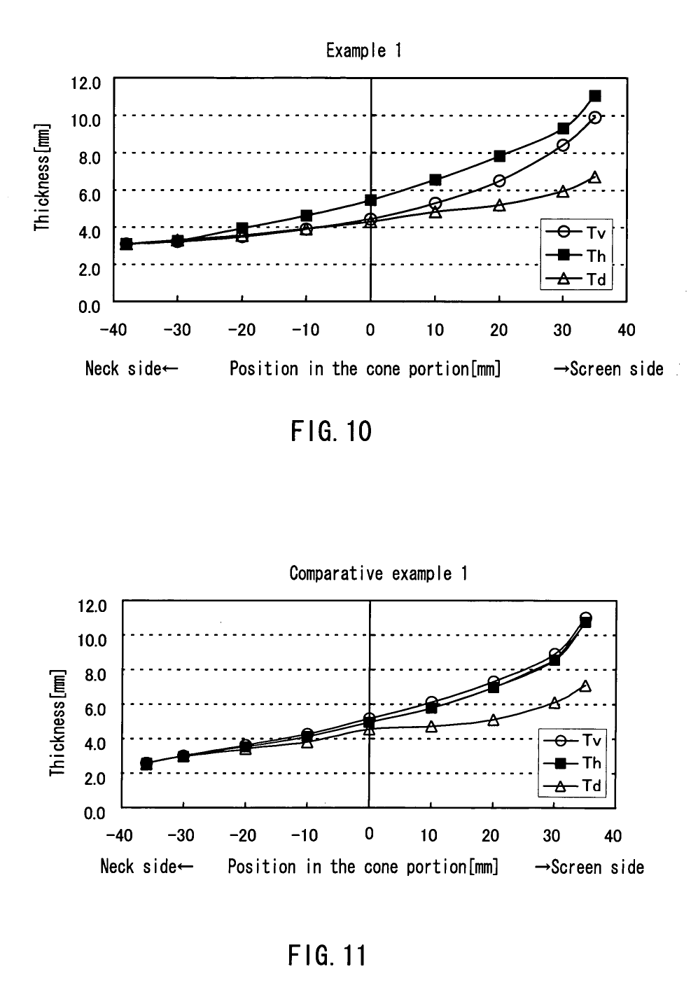

FIG. 10 is a view showing a relationship between the position in the cone portion in the direction of the tube axis and the cross-sectional thicknesses (Th, Tv, Td) in Example 1in Table 1. A position of the origin represents a reference line position, a positive direction along a horizontal axis represents a direction to the screen side, and a negative direction along a horizontal axis represents a direction to the neck side. This is also applied in FIGS. 11, 12, 13 and 15.

The values of Th, Tv and Td shown in Table 1 are the cross-sectional thicknesses at the position that is 20 mm away from the reference line 21 to the screen side, whereas the respective cross-sectional thicknesses in all region of the cone portion are plotted in FIG. 10. As shown in FIG. 10, the relationship of Th>Tv>Td becomes more significant closer to the screen side, and is particularly significant in a range on the phosphor screen side with respect to the reference line.

Whereas, FIG. 11 is a view showing a relationship between the position in the cone portion in the direction of the tube axis and the cross-sectional thicknesses (Th, Tv, Td) in Comparative example 1 in Table 1. It is found that a relationship of TV≧Th>Td is satisfied in the substantially all region of the cone portion in Comparative example 1

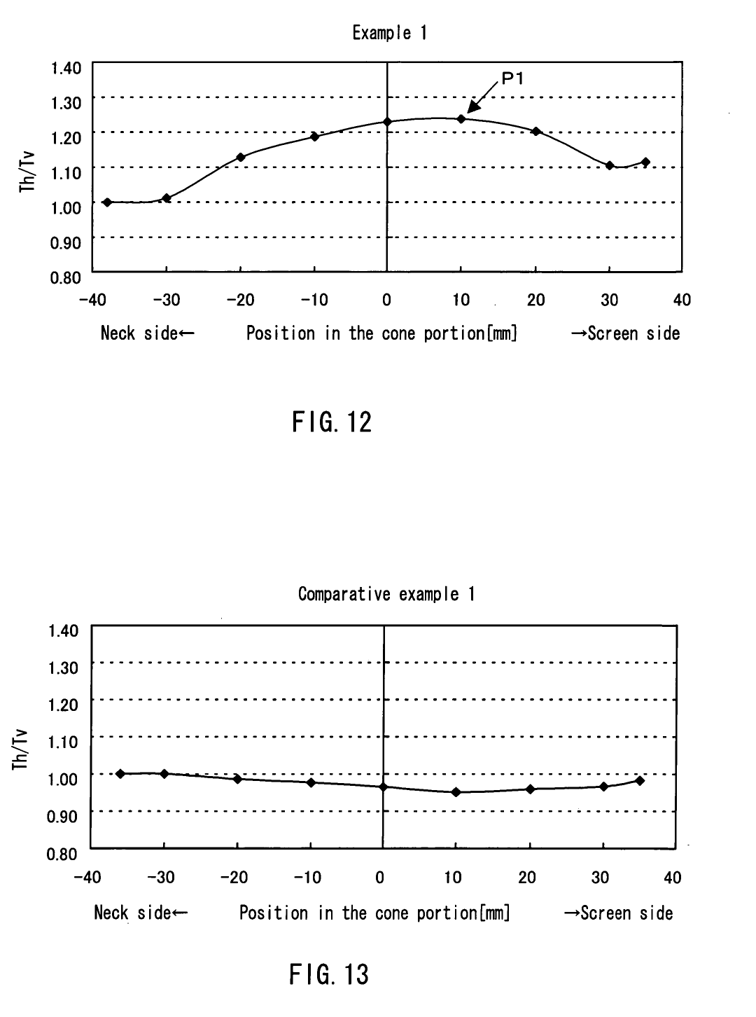

FIG. 12 is a view showing a relationship between the position of the cone portion in the direction of the tube axis and the value of Th/Tv in Example 1 in Table 1. As shown in FIG. 12, the relationship of Th/Tv>1 is satisfied except in the vicinity of the connected portion on the side of the neck portion. In addition, Th/Tv has a maximal value P1 in a position that is 10 mm away from the reference line 21 to the screen side.

As shown in FIG. 5, the angle formed by the deflection track of the electron beam and the horizontal axis 2a has a maximal value, which is an angle formed by the line 76 and the horizontal axis 2a. In addition, in the vicinity of the line 71 on the screen side, the line 71 representing the position of the reference line, there is a portion providing an angle close to this maximal value, that is, a portion that substantially provides a gradient of the line 76. Therefore, in this portion, a depth of the concavity shown as the inner face 42 in FIG. 6 needs to be greater so as to prevent the halation. Thus, as shown in FIG. 12, there is a maximal value of Th/Tv in the vicinity of the reference line on the screen side, where the value of Th/Tv is set to be larger than a remaining portion so as to enhance an efficiency to decrease the maximum vacuum stress.

That is, to increase the value of Th/Tv is more effective on the screen side with respect to the reference line, and is further more effective in the vicinity of the reference line. Based on this, the value of Th/Tv is set in Examples 1 to 3 shown in Table 1. Specifically, as shown in FIG. 12, a relationship of Th/Tv≧1.1 is satisfied on the screen side with respect to the position of the reference line (Position of 0 mm), and in particular, the value of Th/Tv is large in a range from the position of the reference line (Position of 0 mm) to Position of 20 mm.

FIG. 12 shows Example 1, but also in all Examples 1 to 3, the relationship of Th/Tv≧1.1 is satisfied in a range from the position of the reference line to a position that is 85% of the distance (approximately 30 mm in Example 1) from the position of the reference line to the end of the cone portion on the screen side (Position of approximately 35 mm in Example 1).

The relationship between Th on the horizontal axis 2a and Tv on the vertical axis 2b was described above. Here, it is needless to say that thicknesses in the vicinity of the horizontal axis 2a and vertical axis 2b respectively may satisfy the same relationship as the relationship between Th and Tv. Specifically, in a cross section satisfying the relationship of Th>Tv, assuming that a substantial thickness in a region sandwiching the horizontal axis 2a in the direction of the horizontal axis 2a is represented by Th′, a substantial thickness in a region sandwiching the vertical axis 2b in the direction of the vertical axis 2b is represented by Tv′, and lengths of these regions are equal, there may be a range in the regions satisfying the relationship of Th′>Tv′. According to this structure, formation is easy and distributions of the stresses may be smooth.

In Table 3 below, values of Th′ and Tv′ on axes that are obtained by shifting the horizontal axis 2a and the vertical axis 2b in parallel in Example 1 are shown. The values in Table 3 are obtained by measuring in a position that is 20 mm away from the reference line 21 to the screen side.

The “position (mm)” in the left column in Table 1 represents a distance from the horizontal axis 2a or the vertical axis 2b. The “Th′ (min)” in the right column represents a minimum value of Th′ in a range to each position, and the “Tv′ (max)” represents a maximum value of Tv′ in a range to each position.

Therefore, the “Th′(min)/Tv′(max)” represents a minimum value of Th′/Tv′ in the range to each position. Table 3 shows, for example, the value of Th′/Tv′ is needs to be 1 or larger, if measuring in any position in a range where a distance from each axis is 17 mm or smaller.

TABLE 3

| position | | | |
|---|---|---|---|
| (mm) | Th′ (mm) | Tv′ (mm) | Th′(min)/Tv′(max) |
| 20 | 5.9 | 6.8 | 0.87 |
| 17 | 6.7 | 6.7 | 1.00 |
| 15 | 7.2 | 6.6 | 1.09 |
| 10 | 7.6 | 6.5 | 1.17 |
| 5 | 7.8 | 6.5 | 1.20 |
| 0 | 7.8 | 6.5 | 1.20 |

Table 4 below shows values of Th′ and Tv′ on axes that are obtained by shifting the horizontal axis 2a and the vertical axis 2b in parallel in Example 3 are shown. The values in Table 4 are obtained by measuring in the position of the reference line. The description for the values in Table 4 are same as those in Table 3.

TABLE 4

| position | | | |
|---|---|---|---|
| (mm) | Th′ (mm) | Tv′ (mm) | Th′(min)/Tv′(max) |
| 17 | 2.9 | 4.2 | 0.66 |
| 15 | 3.6 | 4.3 | 0.82 |
| 12 | 4.2 | 4.3 | 0.95 |
| 10 | 4.6 | 4.4 | 1.05 |
| 5 | 4.8 | 4.4 | 1.09 |
| 0 | 4.9 | 4.4 | 1.11 |

In the example shown in Table 3 , when the value of Th′/Tv′, that is, the value of Th/Tv, is 1.2 or larger, the relationship of Th′>Tv′ can be satisfied if the position of measurement is in a range where the distance from each axis is smaller than 17 mm. In the example shown in Table 4, when the value of Th′/Tv′, that is, the value of Th/Tv, is larger than 1.1, the relationship of Th′>Tv′ can be satisfied if the position of measurement is in a range where the distance from each axis is 10 mm or smaller.

FIG. 13 is a view showing a relationship between the position in the cone portion in the direction of the tube axis and the value of Th/Tv in Comparative example 1 in Table 1. As described above with reference to FIG. 11, in Comparative example 1, since the relationship of Tv≧Th is satisfied, the value of Th/Tv is 1 or smaller. This is particularly obvious in the range from the reference line to the end on the screen side. This is in the contrast to FIG. 12, in which the value of Th/Tv is large in a range from the reference line to the end of the cone portion on the screen side.

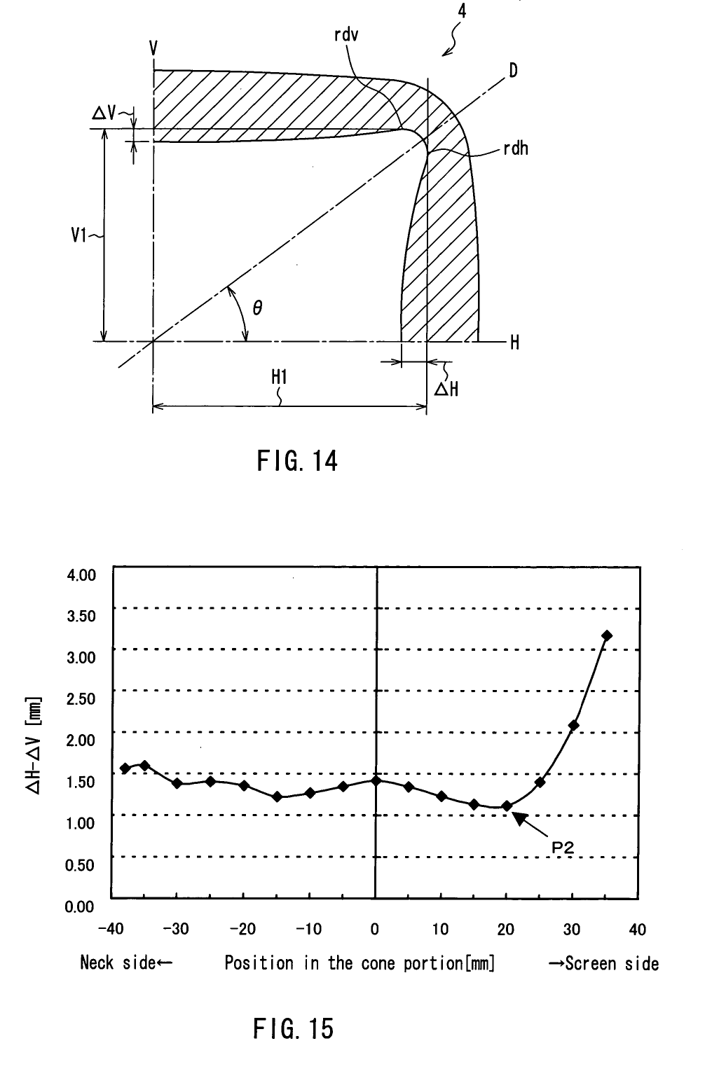

FIG. 14 is a cross-sectional view of the cone portion according to one embodiment of the present invention, taken along a direction perpendicular to the tube axis. The letter rdh denotes a point that has the longest distance from the tube axis in the horizontal direction, among points on the vertical inner face. In the example shown by FIG. 14, a horizontal distance between the tube axis and the point rdh is represented by H1. The letter rdv denotes a point that has the longest distance from the tube axis in the vertical direction, among points on the horizontal inner face. In the example shown by FIG. 14, a vertical distance between the tube axis and the point rdv is represented by V1.

The letter ΔH denotes a maximum height in the horizontal direction from a vertical line passing on the point rdh to the vertical inner face, the letter ΔV denotes a maximum height in the vertical direction from a horizontal line passing on the point rdv to the horizontal inner face. That is, ΔV shows a maximum height of a convexity of the horizontal inner face, and ΔH shows a maximum height of a convexity of the vertical inner face.

As described above with reference to FIG. 6, the inner face of the cone portion in the present embodiment is set to have the relationship of Th>Tv, which is inverse to the conventional relationship of Th<Tv. Therefore, a pincushion shape (the convexity) of the vertical inner face is set to be higher than a pincushion shape of the horizontal inner face.

FIG. 15 shows a relationship between the position in the cone portion on the tube axis and the value of ΔH-ΔV in Example 1in Table 1. In the full range on the tube axis, the relationship of ΔH>ΔV is satisfied, and moreover, a relationship of ΔH-ΔV>1 is satisfied.

The letter P2 in FIG. 15 denotes the value of ΔH-ΔV in the vicinity of a midpoint position between the reference line and a front end of the deflection yoke. In Example 1, the position P2 is 20 mm away from the position of the reference line to the screen side. The value of ΔH-ΔV increases sharply from the position P2 approaching to the screen side.

Here, as shown in FIG. 5, the angle θ formed by the horizontal axis 2a and the deflection track becomes maximal when the electron beam is in the vicinity of the position of the reference line. After that, the angle θ gradually decreases, particularly from the vicinity of the midpoint position of the cone portion approaching to the screen, and thus, the track of the electron beam leans to the horizontal axis 2a side.

Therefore, when the diagonal corner of the cone portion, which is from the vicinity of the midpoint position to the end on the panel portion side, has a shape concaved more deeply in the direction of the horizontal axis, the electron beams can be prevented from striking the inner face of the diagonal corner.

This is why the relationship of ΔH>ΔV is satisfied, and the value of ΔH-ΔV is increased sharply from the position P2 as being closer to the screen side, as mentioned above. When, for example, the position of the point rdh is moved in the horizontal direction so as to increase the distance H1 while maintaining the thickness of the cone portion on the horizontal axis, the diagonal corner may have a shape concaved in the horizontal direction. In this case, ΔH increases, and the value of ΔH-ΔV increases accordingly.

In addition, since the cross section of the cone portion is substantially rectangular-shaped, the electron beams likely approach the inner wall in the vicinity of the short axis (the vertical axis). Therefore, by satisfying the relationship of ΔH>ΔV and flattening the shape of the inner wall in the vicinity of the short axis, the striking of the electron beams can be prevented.

As mentioned above, by satisfying the relationship of ΔH>ΔV, the electron beams can be prevented from striking the inner wall of the diagonal corner and the inner wall in the vicinity of the short axis, which is advantageous for preventing the halation of the electron beams. The larger value of ΔH-ΔV is more advantageous.

In the embodiment mentioned above, it is described that Th denotes a thickness of the tube wall on the horizontal axis 2a, and Tv denotes a thickness of the tube wall on the vertical axis 2b. However, these thicknesses mean substantial thicknesses that determine the whole shape of the tube wall. Specifically, in the cross section satisfying the relationship of Th>Tv as shown in FIG. 7, when the thickness only in the vicinity of the horizontal axis is decreased, a shape satisfying the relationship of Th≦Tv can be obtained while maintaining the whole shape of the tube wall.

However, in the present invention, the purpose for satisfying the relationship of Th>Tv is to obtain a shape in which the stress applied to the whole horizontal wall is increased, and the stress concentration in the vicinity of the diagonal axis is released, as mentioned above.

That is, Th and Tv are base factors for determining the whole shape of the tube wall. Therefore, in the shape where the thickness only in the vicinity of the horizontal axis is partly reduced as mentioned above, there is a case where, not the reduced thickness, but the thickness Th of the form that the concavity is filled so as to have a shape changed naturally in the vicinity of the horizontal axis is a substantial thickness.

This is also applicable to the above-mentioned Th′ in the vicinity of the horizontal axis 2a and Tv′ in the vicinity of the vertical axis 2b.

According to the cathode ray tube of the present invention, the halation can be prevented, the deflection power can be decreased efficiently, and the pressure resistance strength of the vacuum envelope can be secured sufficiently. Thus the present invention is applied effectively to cathode ray tubes that are used for, for example, television receivers and computer displays.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A cathode ray tube comprising:
a vacuum envelope that is provided with an electric gun and includes a panel portion with a phosphor screen formed on an inner face thereof and
a deflection yoke that is disposed on a periphery of the vacuum envelope and deflects electron beams emitted from the electron gun,
wherein the vacuum envelope comprises a neck portion provided with the electron gun, and a cone portion that corresponds to a position where the deflection yoke is disposed and has a cross section taken along a direction perpendicular to a tube axis of the cathode ray tube, which is non-circular shaped in substantially all regions in the direction of the tube axis,
the panel portion is formed substantially symmetrically with respect to a long axis and a short axis that cross each other at a right angle, and
wherein, in a cross section of the cone portion taken along the direction perpendicular to the tube axis, assuming that a substantial thickness of the cone portion on the long axis is represented by Th, a substantial thickness of the cone portion on the short axis is represented by Tv, and a minimum thickness of the cone portion in a diagonal position is represented by Td, there is the cross section satisfying a relationship of Th>Tv>Td.

2. The cathode ray tube according to claim 1, wherein the relationship is satisfied in a range from a position of a reference line that is a reference for a deflection angle to a position that is 85% of a distance from the position of the reference line to an end of the cone portion on the panel portion side.

3. The cathode ray tube according to claim 2, wherein a relationship of Th/Tv≧1.1 is satisfied in the range.

4. The cathode ray tube according to claim 1, wherein, in a cross section satisfying the relationship, assuming that a substantial thickness in a region sandwiching the long axis in a direction of the long axis is represented by Th′, a substantial thickness in a region sandwiching the short axis in a direction of the short axis is represented by Tv′, and lengths of the regions are equal, there is a range in the regions satisfying a relationship of Th′>Tv′.

5. The cathode ray tube according to claim 4, wherein a relationship of Th/Tv≧1.2 is satisfied, and the range of the regions is a range where a distance from each of the axes is smaller than 17 mm.

6. The cathode ray tube according to claim 4, wherein a relationship of Th/Tv>1.1 is satisfied, and the range of the regions is a range where a distance from each of the axes is 10 mm or smaller.

7. The cathode ray tube according to claim 1,
wherein the cross sections of the cone portion in respective positions on the tube axis in a range from a position of a reference line that is a reference for a deflection angle to an end of the cone portion on the panel portion side satisfies a relationship of Th/Tv>1, and
there is a maximal value of Th/Tv in the range.

8. The cathode ray tube according to claim 7, wherein the maximal value ranges between 1.11 and 1.39 inclusive.

9. The cathode ray tube according to claim 1,
wherein, in the cross section of the cone portion taken along the direction perpendicular to the tube axis,
assuming that a point which has a longest distance from the tube axis in a horizontal direction among points on a vertical inner face of the cone portion is represented by rdh,
a point which has a longest distance from the tube axis in the vertical direction among points on an horizontal inner face of the cone portion is represented by rdv,
a maximum height of the vertical inner face in the horizontal direction from a vertical line passing on the point rdh is represented by ΔH, and
a maximum height of the horizontal inner face in the vertical direction from a horizontal line passing on the point rdv is represented by ΔV,
the cross sections in the respective positions on the tube axis in a range from the position of the reference line to the end of the cone portion on the panel portion side satisfy a relationship of ΔH>ΔV.

10. The cathode ray tube according to claim 9, wherein, in a range between a position that is substantially middle of the range from the position of the reference line to the end of the cone portion on the panel portion side and the end of the cone portion on the panel portion side, a value of ΔH-ΔV increases approaching to the panel portion side.
